(19) United States
(12) Patent Application Publication
(10) Pub. No.: US 2010/0124401 A1
(43) Pub. Date: May 20, 2010

(54) Signal processing system, signal processing method, and program

(75) Inventors: Katsunari Miyata, Tokyo (JP); Shinya Tatsumi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/587,260

(22) Filed: Oct. 5, 2009

(30) Foreign Application Priority Data
Oct. 7, 2008 (JP) P2008-260330

(51) Int. Cl. H04N 5/917

(52) U.S. Cl. 386/46; 386/E05.007

(57) ABSTRACT

A signal processing system includes: one or more terminals via which a signal is outputted; and signal control means for sensing whether the connecting destination of each of the one or more terminals is in a state in which the connecting destination can treat an output signal sent via the terminal, and implementing at least one of variable control of a signal transmission path, which leads to the terminal serving as an output terminal, and variable control of a signal processing technique, which is applied to the signal transmission path, on the basis of the result of the sensing.

### CROSS-REFERENCE TO RELATED APPLICATION

The present application claims priority from Japanese Patent Application No. JP 2008-260330 filed in the Japanese Patent Office on Oct. 7, 2008, the entire content of which is incorporated herein by reference.

### BACKGROUND OF THE INVENTION

1. Field of the Invention

The present invention relates to a signal processing system, a signal processing method, and a program. In particularly, the present invention is concerned with a signal processing system, a signal processing method, and a program which can efficiently use a memory bandwidth.

2. Description of the Related Art

In recent years, a technique of efficiently using a limited memory bandwidth has been demanded to be realized for signal processing systems including a Blu-ray Disc (BD) reproducing system and a BD recording system (refer to, for example, JP-A-2006-236056 (patent document 1)).

### SUMMARY OF THE INVENTION

However, the demand is not fully met in a current situation.

Thus, it is desirable to efficiently use a memory bandwidth.

According to an embodiment of the present invention, there is provided a signal processing system that includes one or more terminals via which a signal is outputted, and a signal control means for sensing whether the connecting destination of each of the one or more terminals is in a state in which the connecting destination can treat an output signal sent via the terminal, and implementing at least one of variable control of a signal transmission path, which leads to the terminal serving as an output terminal, and variable control of a signal processing technique, which is applied to the signal transmission path, on the basis of the result of the sensing.

To the signal transmission path, one or more circuit blocks belong. The signal control means controls as the variable control of the signal processing technique permission of the one or more circuit blocks, which belong to the signal transmission path, to act and inhibition thereof from acting.

To the signal transmission path, a memory also belongs. The signal control means controls permission of circuit blocks, which are connected to the memory, to act and inhibition thereof from acting.

The signal control means senses a physical state of connection of the terminal as the state of the connecting destination of the terminal.

The signal control means communicates with the connecting destination of the terminal, and senses the state of the connecting destination of the terminal on the basis of the contents of the communication.

According to another embodiment of the present invention, there are provided a signal processing method and a program which are implemented in the foregoing signal processing system according to the embodiment of the present invention.

In the signal processing system, signal processing method, and program according to the embodiments of the present invention, the signal processing system including one or more terminals via which a signal is outputted or a computer that controls an output device having one or more terminals via which a signal is outputted senses whether the connecting destination of each of the one or more terminals is in a state in which the connecting destination can treat an output signal sent via the terminal. Based on the result of the sensing, at lease one of variable control of a signal transmission path, which leads to the terminal serving as an output terminal, and variable control of a signal processing technique, which is applied to the signal transmission path, is implemented.

As mentioned above, according to the embodiment of the present invention, a memory bandwidth can be efficiently used.

### BRIEF DESCRIPTION OF THE DRAWINGS

FIG. 1 is a block diagram showing an example of the configuration of a BD reproducing system that is an example of a signal processing system to which the technique of the present invention is applied;

FIG. 2 is a block diagram for use in explaining actions to be performed in the BD reproducing system in a case where only an HDMI terminal 19-1 shown in FIG. 1 is connected;

FIG. 3 is a block diagram for use in explaining the BD reproducing system in a case where only a D terminal cum component terminal 19-2 shown in FIG. 1 is connected;

FIG. 4 is a block diagram for use in explaining the BD reproducing system in a case where only an S terminal 19-3 shown in FIG. 1 is connected;

FIG. 5 is a block diagram for use in explaining the BD reproducing system in a case where only a composite terminal 19-4 shown in FIG. 1 is connected;

FIG. 6 is a block diagram for use in explaining the BD reproducing system in a case where the connecting situations of the output terminals shown in FIG. 1 are changed;

FIG. 7 is a flowchart describing an example of signal control processing to be executed by the signal processing system shown in FIG. 1; and

FIG. 8 is a block diagram showing an example of the configuration of a computer that is included in a signal processing system to which the present invention is applied or that drives the signal processing system.

### DESCRIPTION OF THE PREFERRED EMBODIMENTS

### Outline of a Technique According to the Invention

For a better understanding of the present invention, the contents of a description made in Summary of the Invention will be detailed below.

As mentioned above, signal processing systems including a BD reproducing system and a BD recording system are demanded to efficiently use a limited memory bandwidth.

The signal processing system has multiple kinds of output terminals. Users rarely employ all of the multiple output terminals. However, when a consideration is taken into user-convenience, the signal processing system should preferably output a video signal or an audio signal via all the kinds of output terminals.

However, the output of the video signal or audio signal via all the kinds of output terminals leads to an increase in an occupied width of the memory bandwidth, that is, results in a situation in which the aforesaid demand is not met.

The present inventor has invented a technique described below. Namely, a signal processing system having multiple output terminals decides whether the connecting destination of an output terminal can treat an output signal. Based on the result of the decision, the signal processing system appropriately controls an internal signal transmission path thereof (a data path to be described later) and signal processing alike. Owing to realization of the technique (hereinafter, referred to as the technique of the embodiment of the present invention), the memory bandwidth in the signal processing system can be efficiently used.

(Example of the Configuration of a Signal Processing System to which the Present Invention is Applied)

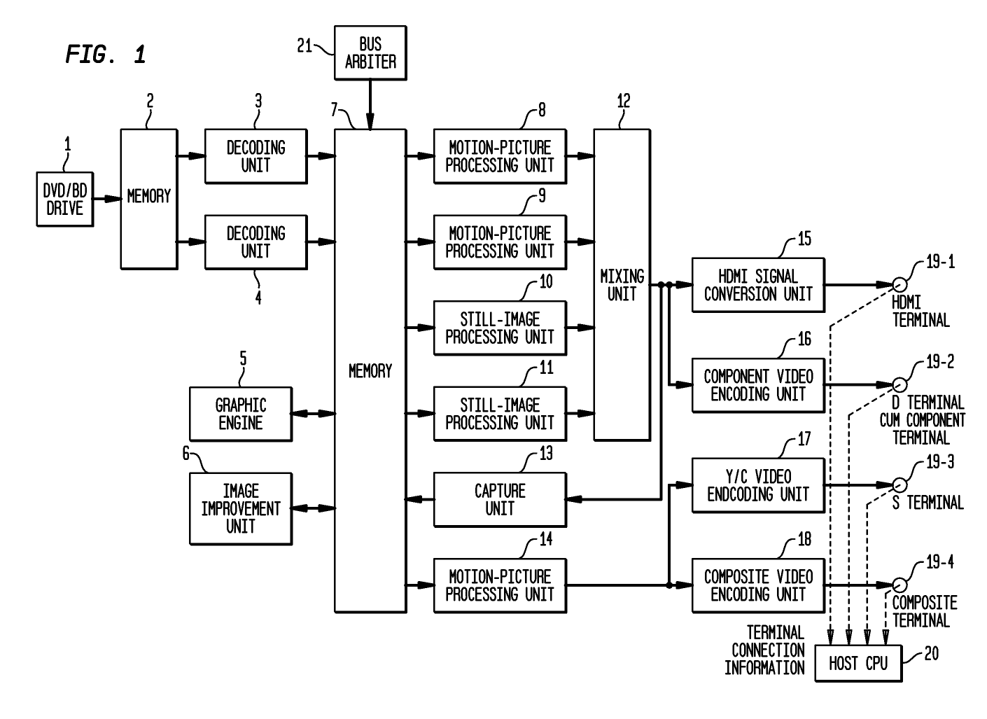

FIG. 1 is a block diagram showing an example of the configuration of a BD reproducing system that is an example of a signal processing system to which the technique of the embodiment of the present invention is applied. In FIG. 1, units required in a case where an object of processing of the signal processing system is a video signal are shown. In other words, in FIG. 1, the other units including units required in a case where the object of processing of the signal processing system is an audio signal are excluded.

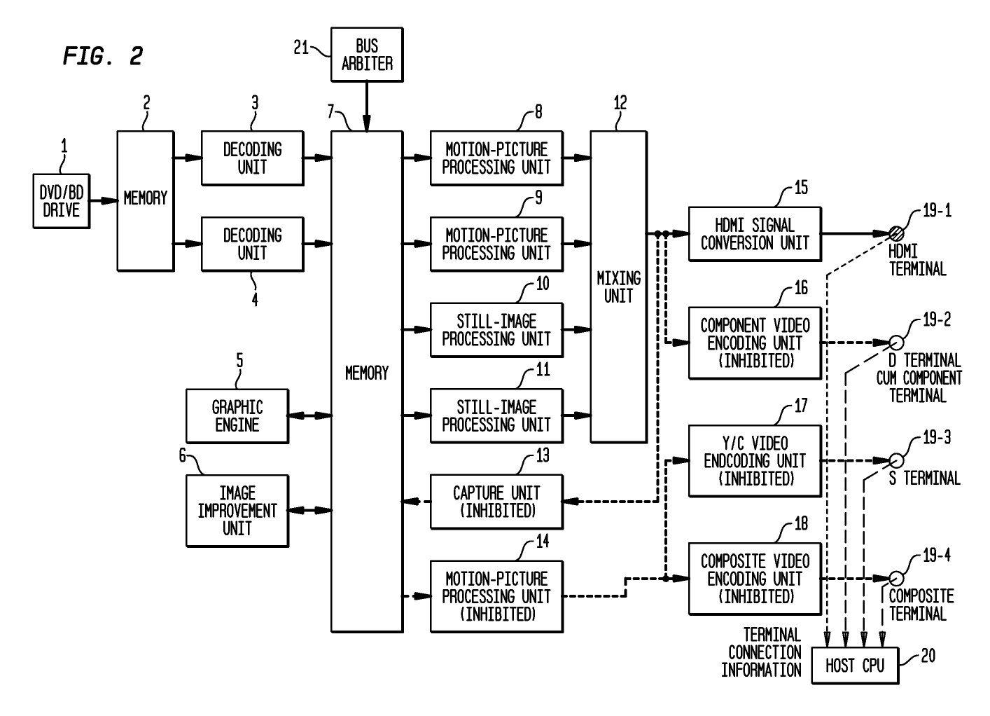

Hatched graphics in the drawing express units that may be inhibited from acting. Namely, in FIG. 2 to FIG. 5 to be referred to later, graphics marked with diagonal lines express units having been inhibited from acting. Thus, some graphics in each of the drawings are hatched and some other graphics therein are marked with diagonal lines. This is intended to clearly signify whether units are inhibited from acting.

The BD reproducing system has components ranging from a DVD/BD drive 1 to a bus arbiter 21.

The DVD/BD drive 1 reads data recorded in a digital versatile disc (DVD) or a Blu-ray Disc (BD), and writes the data in a memory 2. For example, compressed encoded data of video data is recorded in the DVD or BD. That is, the compressed and encoded data obtained by compressing and encoding the video data according to the Moving Picture Experts Group2 (MPEG2) standards or Advanced Video Coding (AVC) standards is recorded in the DVD or BD. If necessary, compressed and encoded data of secondary data is recorded in the DVD or BD. The secondary data is employed in, for example, picture-in-picture (PiP) display of the contents of a BD read-only memory (ROM). The secondary data falls into video data (motion-picture data) and still-image data.

The memory 2 holds data inputted from the DVD/BD drive 1.

A decoding unit 3 reads compressed and encoded data of video data from among data items stored in the memory 2. The decoding unit 3 performs decoding processing on the compressed and encoded data. The decoded video data is written in a memory 7.

A decoding unit 4 reads compressed and encoded data of secondary data from among data items stored in the memory 2. The decoding unit 4 performs decoding processing on the compressed and encoded data. The decoded secondary data is written in the memory 7.

Thus, video data or still-image data is stored in the memory 7.

A graphic engine 5 is, for example, dedicated hardware capable of performing image processing on a still image at a high speed. As the image processing to be performed on a still image, there is, for example, transfer of a rectangle in a still image, graphic rendering, color conversion, mixing, size conversion, font rendering, run-length decoding, or the like.

The graphic engine 5 performs the above image processing on still-image data read from the memory 7. The still-image data having undergone the image processing is returned to the memory 7.

An image quality improvement unit 6 is dedicated hardware capable of performing image processing on a motion picture. As the image processing to be performed on a motion picture, there is, for example, scaling, interlaced-to-progressive scanning conversion, enhancement, noise reduction, or the like.

The image quality improvement unit 6 performs the above image processing on motion-picture data read from the memory 7. The motion-picture data having undergone the image processing is returned to the memory 7.

Motion-picture processing units 8 and 9 perform scaling processing, which includes enlargement or reduction of an image, on the motion-picture data read from the memory 7 according to, for example, an output resolution. The motion-picture data having undergone the scaling processing is fed to a mixing unit 12.

Still-image processing units 10 and 11 perform scaling processing, which includes enlargement of an image and reduction thereof, on still-image data read from the memory 7 according to, for example, an output resolution. The still-image data having undergone the scaling processing is fed to the mixing unit 12.

The mixing unit 12 mixes motion-picture data items sent from the motion-picture processing units 8 and 9 with still-image data items sent from the still-image processing units 10 and 11 in designated order or at a designated transmittance. Data resulting from the mixing (hereinafter, referred to as mixture image data) is fed to each of an HDMI signal conversion unit 15 and a component video encoding unit 16.

The HDMI signal conversion unit 15 converts the mixture image data sent from the mixing unit 12 into an HDMI signal. The HDMI signal is outputted to outside via an HDMI terminal 19-1.

The component video encoding unit 16 converts the mixture image data sent from the mixing unit 12 into a component analog signal. The component analog signal is outputted to outside via a D terminal cum component terminal 19-2.

The mixture image data outputted to outside as the HDMI signal or component analog signal is fed from the mixing unit 12 to a capture unit 13. The capture unit 13 writes the mixture image data in the memory 7.

The motion-picture processing unit 14 reads the mixture image data written in the memory 7. The motion-picture processing unit 14 converts the mixture image data into a standard-definition (SD) signal conformable to the 480i or 576i scanning method. The SD signal is fed to each of a Y/C video encoding unit 17 and a composite video encoding unit 18.

The Y/C video encoding unit 17 converts the SD signal sent from the motion-picture processing unit 14 into a Y/C analog signal. The Y/C analog signal is outputted to outside via an S terminal 19-3.

The composite video encoding unit 19 converts the SD signal sent from the motion-picture processing unit 14 into a composite analog signal. The composite analog signal is outputted to outside via a composite terminal 19-4.

When the HDMI terminal 19-1, D terminal cum component terminal 19-2, S terminal 19-3, and composite terminal 19-4 need not be discriminated from one another, they are simply called terminals 19.

The contents of the above description will be briefed below. Namely, data read from the DVD or BD by the DVD/BD drive 1 is transmitted over a predetermined path (hereinafter, referred to as a data path), which passes through one or more units, before the data is outputted to outside via the terminal 19. More particularly, the BD reproducing system of the example shown in FIG. 1 has first to fourth data paths to be described below.

The first data path refers to a path leading from the DVD/BD driver 1 to the HDMI terminal 19-1. More particularly, the first data path links the DVD/BD driver 1, memory 2, decoding unit 3 or 4, memory 7, motion-picture processing unit 8 or 9, still-image processing unit 10 or 11, mixing unit 12, HDMI signal conversion unit 15, and HDMI terminal 19-1 in that order.

The second data path refers to a path leading from the DVD/BD driver 1 to the D terminal cum component terminal 19-2. More particularly, part of the second data path ending with the mixing unit 12 is identical to the counterpart of the first data path. The other part of the second data path links the mixing unit 12, component video encoding unit 16, and D terminal cum component terminal 19-2 in that order.

The third data path refers to a path leading from the DVD/BD driver 1 to the S terminal 19-3. More particularly, part of the third data path ending with the mixing unit 12 is identical to the counterpart of the first data path. The other part of the third data path links the mixing unit 12, capture unit 13, memory 7, motion-picture processing unit 14, Y/C video encoding unit 17, and S terminal 19-3 in that order.

The fourth data path refers to a path leading from the DVD/BD drive 1 to the composite terminal 19-4. More particularly, part of the fourth data path ending with the motion-picture processing unit 14 is identical to the counterpart of the third data path. The other part of the fourth data path links the motion-picture processing unit 14, composite video encoding unit 18, and composite terminal 19-4 in that order.

Incidentally, if necessary, a path between the memory 7 and graphic engine 5 or a path between the memory 7 and image quality improvement unit 6 is appropriately added to any of the first to fourth data paths.

A host central processing unit (CPU) 20 controls all the actions to be performed in the BD reproducing system.

For example, assume that information (hereinafter, connecting-destination state information) signifying whether the connecting destination of the terminal 19 is in a state in which the connecting destination can treat an output signal sent via the terminal 19 or in a state in which the connecting destination may not be able to treat the output signal is fed from the terminal 19 to the host CPU 20. Herein, the state in which the connecting destination may not be able to treat the output signal includes a state in which since the terminal 19 is connected to the connecting destination, the output signal will be transmitted to the connecting destination but the transmitted output signal will not be treated for reasons on the connecting destination side. Further, a state in which since the terminal 19 is not connected to the connecting destination, the output signal will not be transmitted to the connecting destination and will therefore not be treated by the connecting destination is also included in the state in which the connecting destination may not be able to treat the output signal.

Connecting-destination state information may be information with which the host CPU 20 can identify the state of the connecting destination of the terminal 19 (including an unconnected state). The form of the connecting-destination state image is not limited to any specific one but may be an arbitrary one. For example, when the host CPU 20 can detect the physical situation of the terminal 19, the result of the detection may be adopted as the connecting-destination state information. For example, when the host CPU 20 or any other unit (including the terminal 19 itself) can carry out predetermined communication with the connecting destination of the terminal 19, at least part of the contents of the communication may be adopted as the connecting-destination state information.

In the present embodiment, the physical situation of the terminal 19, that is, a situation in which a cable is or is not coupled to the terminal 19 (hereinafter, referred to as a terminal connecting situation) is adopted. Therefore, information on the terminal connecting situation (hereinafter, referred to as terminal connection information) is adopted as the connecting-destination state information.

More particularly, the terminal connecting situation of the HDMI terminal 19-1 can be sensed under the HDMI standards. Therefore, the result of the sensing is adopted as the terminal connection information.

When the D terminal cum component terminal 19-2 serves as a D terminal, if a hot plug detection terminal stipulated in the standards is utilized, the terminal connecting situation can be sensed. Therefore, the result of the sensing is adopted as the terminal connection information.

When the D terminal cum component terminal 19-2 serves as a component terminal, a terminal component that outputs a cable connecting situation is incorporated in the terminal. The cable connecting situation outputted from the terminal component is adopted as the terminal connection information.

The S terminal 19-3 also has a terminal component, which outputs a cable connecting situation, incorporated therein. The cable connecting situation outputted from the terminal component is adopted as the terminal connection information.

The composite terminal 19-4 also has a terminal component, which outputs a cable connecting situation, incorporated therein. The cable connecting situation outputted from the terminal component is adopted as the terminal connection information.

As mentioned above, the terminal connection information on the terminal 19 is fed to the host CPU 20. Based on the terminal connection information on the terminal 19, the host CPU 20 controls the data path leading to the terminal 19 or processing to be performed on data transmitted over the data path.

More particularly, for example, when terminal connection information signifying that no cable is coupled to the terminal 19 is fed to the host CPU 20, the host CPU 20 decides that the data path leading to the terminal 19 is invalid. The host CPU 20 then executes the processing of inhibiting at least part of the units, which belong to the invalid data path, from acting. Herein, at least part of the units is described to be inhibited from acting, because some units also belong other data paths. When the other data paths are valid, the units that also belong to the other data paths are not inhibited from acting.

Thus, the actions of unnecessary units are suspended. This contributes to power saving of the entire BD reproducing system shown in FIG. 1 and is therefore advantageous. In addition, since a signal is not transmitted over the invalid data path, an advantage that radiation or noise is reduced may be exerted.

Further, when the actions of the units that belong to the invalid data path and are connected to the memory 7 (hereinafter, referred to as memory-connected units) are suspended, an advantage described below will be exerted. Specifically, a memory bandwidth for the memory 7 to be used by the memory-connected units belonging to the invalid data path becomes unnecessary. Therefore, an advantage that access to the memory 7 gained by the other memory-connected units can be speeded up is exerted. The advantage will be detailed below.

The bus arbiter 21 controls input or output of data between the memory 7 and the memory-connected units. In the example shown in FIG. 1, the memory-connected units include, in addition to the units ranging from the decoding unit 3 to the image improvement unit 6, the units ranging from the motion-picture processing unit 8 to the motion-picture processing unit 14 that will be described later.

More particularly, the bus arbiter 21 manages and controls a schedule of accesses to the memory 7 (hereinafter, referred to as memory accesses) to be gained by the memory-connected units. Specifically, the bus arbiter 21 manages and controls, for example, priorities of the memory accesses (hereinafter, referred to as memory access priorities) or memory-access occupation times.

When the memory-connected units are classified from the viewpoint of memory access, the memory-connected units are broadly classified into first units and second units. The first units refer to units for which the memory access is requested to be exactly real time. The first units shall therefore be called real-time units. In contrast, the second units refer to units for which the memory access is not requested to be real time but may be gained at any appropriate time. The second units shall be called non-real time units.

In the example shown in FIG. 1, the real-time units refer to the decoding units 3 and 4, motion-picture processing units 8, 9, and 14, still-image processing units 10 and 11, and capture unit 13.

When the real-time unit fails to terminate processing within a period of a vertical synchronizing (hereinafter, sync) signal, a picture represented by an output signal sent via the terminal 19 is displayed at the connecting destination, the picture is spoiled. However, the number of memory accesses required for the period of a vertical sync signal is determined.

In contrast, in the example shown in FIG. 1, the non-real time units refer to the graphic engine 5, image quality improvement unit 6, and host CPU 20 to be described later.

A memory access priority given to the non-real time units is lower than a memory access priority given to the real-time units. During the period of a vertical sync signal, the memory bandwidth is used for access to the memory 7 gained by the real-time units. At this time, if part of the memory bandwidth for the memory 7 is left unused, access to the memory 7 is gained by the non-real time units in the remaining part of the memory bandwidth.

As mentioned above, the smaller the number of accesses to be gained by the real-time units is, the wider the memory bandwidth the graphic engine 5, image quality improvement unit 6, and host CPU 20, which are the non-real time units, can use is. Therefore, when the real-time units belonging to the invalid data path alone are stopped, the number of memory accesses to be gained by the graphic engine 5, image quality improvement unit 6, or host CPU 20 increases. As a result, improvement in performance of rendering an image in a BD-ROM or improvement in response to a user manipulation can be achieved.

(Example of Actions to be Performed in a Signal Processing System to which the Present Invention is Applied)

FIG. 2 is a diagram for use in explaining actions to be performed in the BD reproducing system of the example shown in FIG. 1 in a case where a cable is coupled to the HDMI terminal 19-1 alone.

In FIG. 2 to FIG. 5, units inhibited from acting are identified by the legend “(Inhibited)”, and data paths over which data is not transmitted are expressed with dashed lines.

Arrows extending from the terminals, which range from the HDMI terminal 19-1 to the composite terminal 19-4, to the host CPU 20 express paths over which terminal connection information is fed. Among the paths over which the terminal connection information is fed, the path over which the terminal connection information “Connected” is fed is expressed with a dashed line, and the paths over which the terminal connection information “Unconnected” is fed are expressed with dot-dash lines. The terminal connection information “Unconnected” is terminal connection information signifying that the terminal 19 is in an unconnected state. The terminal connection information “Connected” is terminal connection information signifying that the terminal 19 is in a connected state.

In the example shown in FIG. 2, Connected is fed from the HDMI terminal 19-1 to the host CPU 20, while Unconnected is fed from the D terminal cum component terminal 19-2, S terminal 19-3, and composite terminal 19-4 thereto. Therefore, the host CPU 20 senses that a cable is coupled to the HDMI terminal 19-1 alone. The host CPU 20 decides that the aforesaid first data path alone is valid but the other data paths are invalid. The host CPU 20 executes the processing of inhibiting the units, which belong to the invalid data path but do not belong to the first data path, from acting.

More particularly, in the example shown in FIG. 2, the capture unit 13, motion-picture processing unit 14, component video encoding unit 16, Y/C video encoding unit 17, and composite video encoding unit 18 are inhibited from acting.

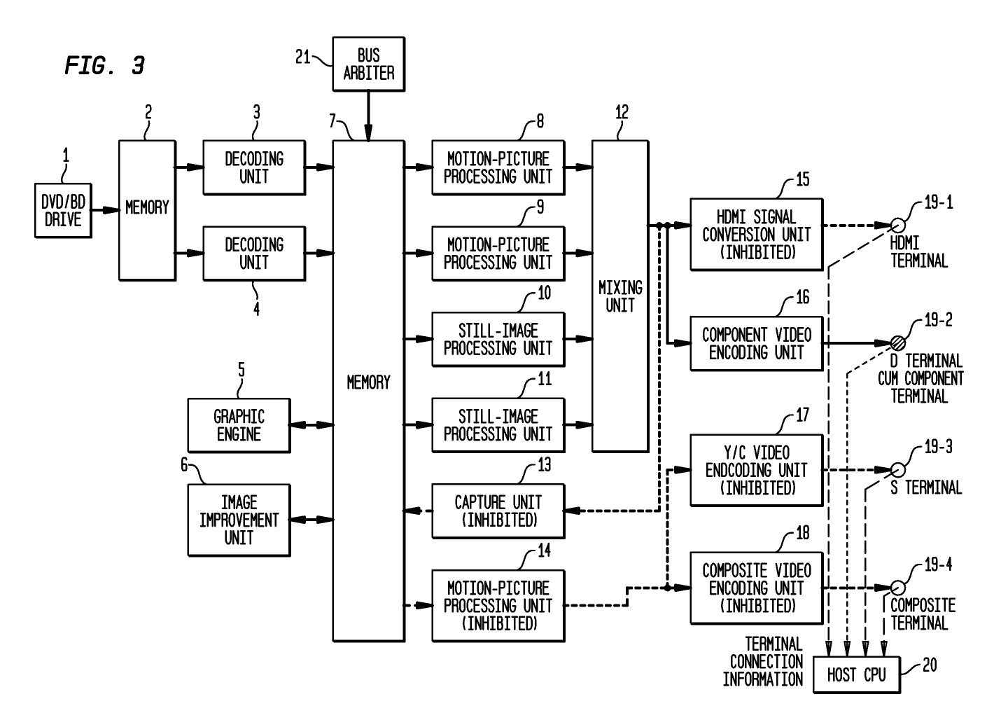

FIG. 3 is a diagram for use in explaining actions to be performed in the BD reproducing system of the example shown in FIG. 1 in a case where a cable is coupled to the D terminal cum component terminal 19-2 alone.

In the example shown in FIG. 3, Connected is fed from the D terminal cum component terminal 19-2 to the host CPU 20, while Unconnected is fed from the HDMI terminal 19-2, S terminal 19-3, and composite terminal 19-4 thereto. Therefore, the host CPU 20 senses that a cable is coupled to the D terminal cum component terminal 19-2 alone. The host CPU 20 decides that the second data path alone is valid but the other data paths are invalid. The host CPU 20 executes the processing of inhibiting the units, which belong to the invalid data path but do not belong to the second data path, from acting.

More particularly, in the example shown in FIG. 3, the capture unit 13, motion-picture processing unit 14, HDMI signal conversion unit 15, Y/C video encoding unit 17, and composite video encoding unit 18 are inhibited from acting.

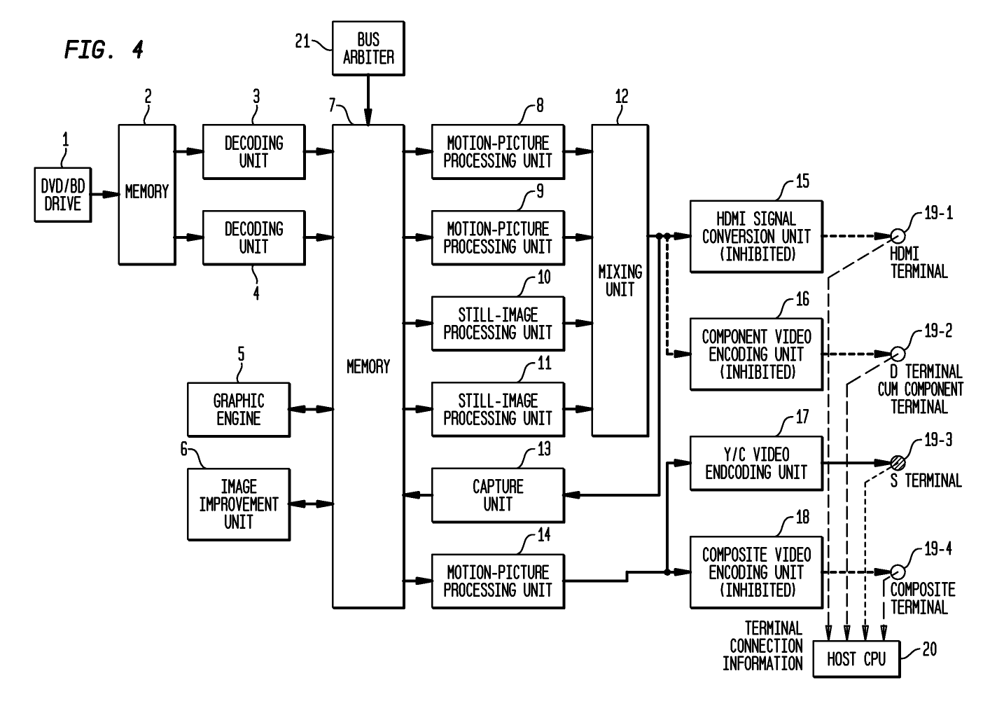

FIG. 4 is a diagram for use in explaining actions to be performed in the BD reproducing system of the example shown in FIG. 1 in a case where a cable is coupled to the S terminal 19-3 alone.

In the example shown in FIG. 4, Connected is fed from the S terminal 19-3 to the host CPU 20, while Unconnected is fed from the HDMI terminal 19-1, D terminal cum component terminal 19-2, and composite terminal 19-4 thereto. Therefore, the host CPU 20 senses that a cable is coupled to the S terminal 19-3 alone. The host CPU 20 decides that the aforesaid third data path alone is valid but the other data paths are invalid. The host CPU 20 executes the processing of inhibiting the units, which belong to the invalid data path but do not belong to the third data path, from acting.

More particularly, in the example shown in FIG. 4, the host CPU 20 inhibits the HDMI signal conversion unit 15, component video encoding unit 16, and composite video encoding unit 18 from acting.

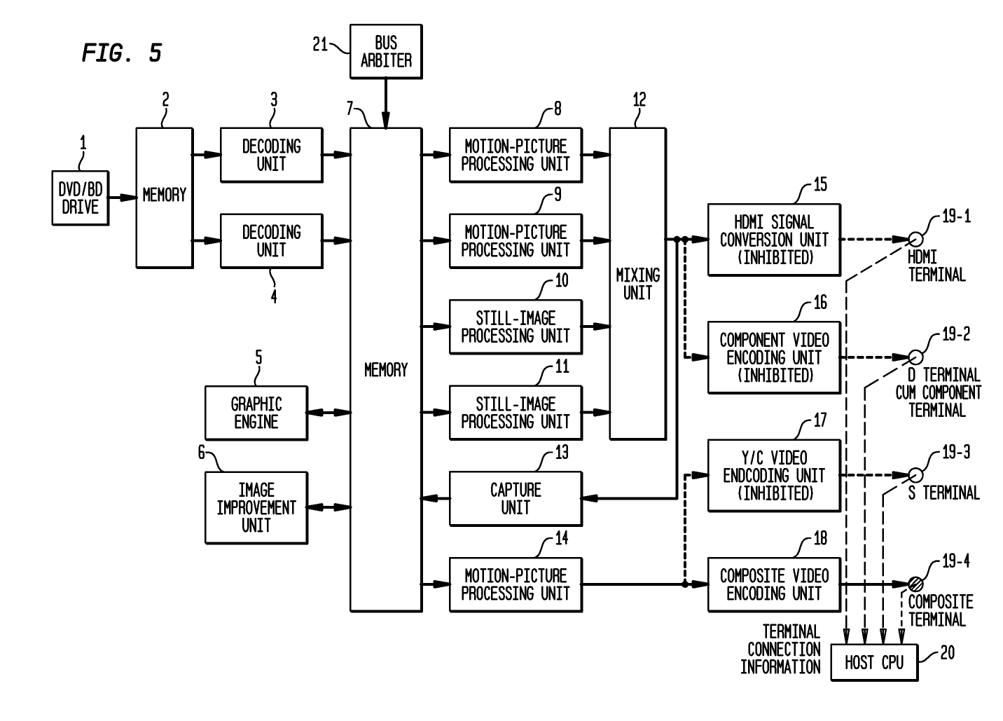

FIG. 5 is a diagram for use in explaining actions to be performed in the BD reproducing system of the example shown in FIG. 1 in a case where a cable is coupled to the composite terminal 19-4 alone.

In the example shown in FIG. 5, Connected is fed from the composite terminal 19-4 to the host CPU 20, while Unconnected is fed from the HDMI terminal 19-1, D terminal cum component terminal 19-2, and S terminal 19-3 thereto. Therefore, the host CPU 20 senses that a cable is coupled to the composite terminal 19-4 alone. The host CPU 20 decides that the fourth data path is valid but the other data paths are invalid. The host CPU 20 executes the processing of inhibiting the units, which belong to the invalid data path but do not belong to the fourth data path, from acting.

More particularly, in the example shown in FIG. 5, the host CPU 20 inhibits the HDMI signal conversion unit 15, component video encoding unit 16, and Y/C video encoding unit 17 from acting.

As described in conjunction with FIG. 2 to FIG. 5, the units that access the memory 7 are only the memory-connected units belonging to valid paths out of the first to fourth data paths. In other words, the memory-connected units belonging to an invalid path are inhibited from acting, and will therefore not access the memory 7. Therefore, a signal processing system to which the present invention is applied can suppress a memory bandwidth.

Referring to FIG. 2 to FIG. 5, the actions to be performed in the BD reproducing system in a case where one of the terminals 19 is connected have been described so far. For cases where multiple terminals are connected, the OR of the descriptions made in relation to the respective terminals is adopted. The descriptions on the cases where multiple terminals are connected will be omitted.

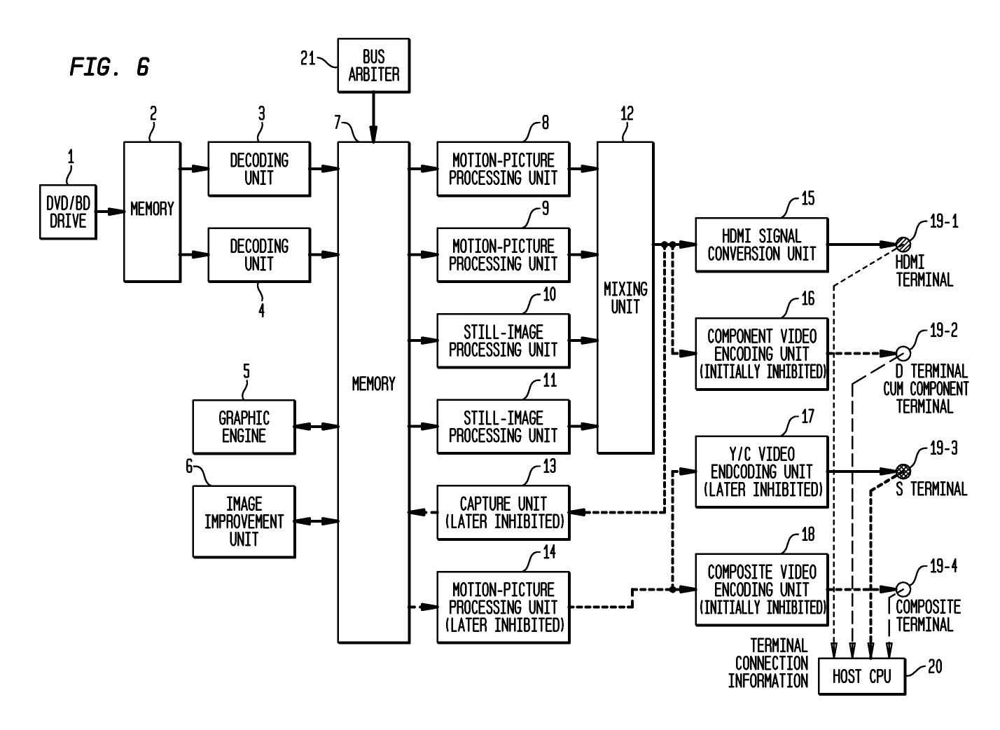

FIG. 6 is a diagram for use in explaining actions to be performed in the BD reproducing system of the example shown in FIG. 1 in a case where a user has pulled out a cable from the S terminal 19-3 in a state (hereinafter, referred to as an initial state) in which cables are coupled to the HDMI terminal 19-1 and S terminal 19-3 respectively.

In FIG. 6, units inhibited from acting in the initial state are identified by the legend “(Initially Inhibited)”, and units that are inhibited from acting in a case where a cable is pulled out of the S terminal 19-3 are identified by the legend “(Later Inhibited)”.

When the actions described in conjunction with FIG. 2 are combined with those described in conjunction with FIG. 4, the initial state is established. In other words, in the initial state, the first data path and third data path are valid. Therefore, in the initial state, the component video encoding unit 16 and composite video encoding unit 18 are inhibited from acting. In contrast, the capture unit 13, motion-picture processing unit 14, and Y/C video encoding unit 17 are permitted to act.

Assume that a user pulls out the cable coupled to the S terminal 19-3.

To the host CPU 20, ‘Connected’ is fed from the HDMI terminal 19-1, while Unconnected is fed from the D terminal cum component terminal 19-2, S terminal 19-3, and composite terminal 19-4. Therefore, the host CPU 20 senses that the HDMI terminal 19-1 alone is connected. Further, the host CPU 20 compares the pieces of information with pieces of terminal connection information, which are fed in the initial state, so as to sense that the S terminal 19-3 has the cable thereof pulled out (is newly left unconnected).

Since the S terminal 19-3 has the cable thereof pulled out, the host CPU 20 decides that the third data path is invalid. In other words, the host CPU 20 decides that the first data path alone is valid but the other data paths are invalid. The host CPU 20 executes the processing of inhibiting the units, which belong to the invalid data path but do not belong to the first data path, from acting. Therefore, the capture unit 13, motion-picture processing unit 14, and Y/C video encoding unit 17 are inhibited from acting. Naturally, the inhibition of the component video encoding unit and composite video encoding unit 18 from acting is continued.

Since the capture unit 13 and motion-picture processing unit 14 are inhibited from acting, the number of units that access the memory 7 gets smaller than the number of units attained in the initial state. Therefore, the host CPU reconfigures the bus arbiter 21 for the purpose of optimizing memory access control.

The reconfiguration facility for reconfiguring the bus arbiter 21 may be incorporated as a hardware facility in the bus arbiter 21. In this case, the hardware of the bus arbiter 21 performs the reconfiguration in place of the host CPU 20.

As mentioned above, units that access the memory 7 are units that have to access the memory 7 so as to provide an output via the HDMI terminal 19-1, that is, only memory-connected units belonging to the first data path. Namely, memory-connected units that do not belong to the first data path (the capture unit 13 and motion-picture processing unit 14) are inhibited from acting and will therefore not access the memory 7. Therefore, a signal processing system to which the present invention is applied can suppress a memory bandwidth.

The actions to be performed in the BD reproducing system in a case where a user pulls out the cable from the S terminal 19-3 in a state in which cables are coupled to the HDMI terminal 19-1 and S terminal 19-3 respectively have been described so far.

Even when an output terminal is newly connected, the host CPU 20 senses that the terminal is newly connected, permits use of a data path, starts necessary units, and reconfigures the bus arbiter 21.

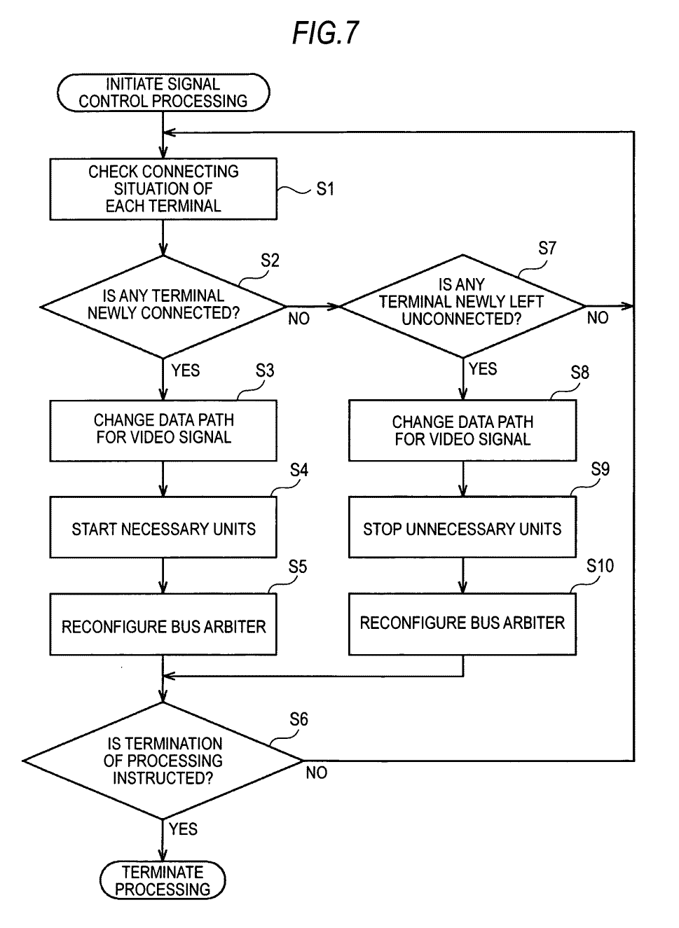

The same processing as the foregoing one is performed even when the terminal 19 other than the ones described in conjunction with FIG. 6 is pulled out or inserted. A detailed example of the processing will be described using the flowchart of FIG. 7.

(Example of a Processing Method for a Signal Processing System to which the Present Invention is Applied)

FIG. 7 is a flowchart describing an example of the processing of controlling memory access by sensing connected output terminals (hereinafter, referred to as signal control processing) which is executed in the BD reproducing system of the example shown in FIG. 1.

At step S1, the host CPU 20 checks the connecting situations of the terminals 19. Namely, the host CPU 20 senses the terminal-connecting situations on the basis of pieces of terminal connection information inputted from the terminals 19.

At step S2, the host CPU 20 decides whether a user has newly connected any of the terminals 19.

Unless a cable is coupled to an unconnected terminal 19, the host CPU 20 decides at step S2 that any terminal is not newly connected. The signal control processing proceeds to step S7. However, the pieces of processing to be performed at step S7 and thereafter will be described later.

In contrast, if a cable is inserted into any of the unconnected terminals 19, a decision is made at step S2 that any of the terminals 19 is newly connected. The signal control processing proceeds to step S3.

At step S3, the host CPU 20 changes a data path for a video signal. Specifically, since the host CPU 20 decides at step S2 that any of the terminals 19 is newly connected, the host CPU 20 validates a data path leading to the newly connected terminal 19 that serves as an output terminal.

At step S4, the host CPU 20 starts necessary units. Specifically, the units that belong to the validated data path and have been inhibited from acting are permitted to act (inhibition is lifted). Incidentally, the units that have been permitted to act from the beginning are still permitted to act.

At step S5, the host CPU 20 reconfigures the bus arbiter 21. Specifically, the host CPU 20 reconfigures the bus arbiter so that memory access control will be optimized despite an increase in the number of units, which access the memory 7, derived from the fact that any terminal is newly connected.

At step S6, the host CPU 20 decides whether termination of the signal control processing has been instructed.

If the termination of the signal control processing is instructed, Yes is recognized at step S6, and the signal control processing is terminated.

In contrast, unless the termination of the signal control processing is instructed, No is recognized at step S6, and the signal control processing is returned to step S1. The subsequent pieces of processing are repeated.

An example of the signal control processing to be executed when any terminal is newly connected has been described so far.

In contrast, if any terminal is not newly connected, No is recognized at step S2, and the signal control processing proceeds to step S7. At step S7, the host CPU 20 decides whether any terminal is newly left unconnected.

If all of the terminals 19 coupled to cables remain intact, that is, if none of the cables is pulled out of the terminals 19, a decision is made at step S7 that any terminal is not newly left unconnected. The signal control processing is returned to step S1, and the subsequent pieces of processing are repeated.

In contrast, if a cable is pulled out of one or more of the terminals 19, a decision is made at step S7 that any terminal is newly left unconnected. The signal control processing proceeds to step S8.

At step S8, the host CPU 20 changes a data path for a video signal from one to another. Specifically, since the host CPU 20 decides at step S7 that any of the terminals 19 is newly left unconnected, the host CPU 20 invalidates the data path leading to the terminal 19 from which a cable is pulled out and which serves as an output terminal.

At step S9, the host CPU 20 stops unnecessary units. Specifically, units belonging solely to the invalidated data path, that is, units that do not belong to any other valid data paths are inhibited from acting. Incidentally, units that have been inhibited from acting from the beginning are still inhibited from acting.

At step S10, the host CPU 20 reconfigures the bus arbiter 21. Specifically, the host CPU 20 reconfigures the bus arbiter so that memory access control will be optimized despite a decrease in the number of units, which access the memory 7, derived from the fact that any terminal is newly left unconnected. Thereafter, the signal control processing proceeds to step S6.

As mentioned above, a signal processing system to which the present invention is applied invalidates a data path, which becomes unnecessary from the viewpoint of the connecting situations of multiple output terminals, and inhibits units, which belong solely to the invalid data path, from acting. As a result, the signal processing system to which the present invention is applied can widen a memory bandwidth required for units other than the unnecessary units to act. Eventually, the performance of the entire signal processing system improves.

In particular, as a current tendency backed up with prevalence of high-definition (HD) television, users often use only the output terminal 19 for a HD signal, that is, in the aforesaid examples, the HDMI terminal 19-1 or D terminal cum component terminal 19-2. In other words, the output terminal for a standard-definition (SD) signal, that is, in the aforesaid examples, the S terminal 193 and composite terminal 19-4 are often left unused. In this case, the application of the present invention would provide an outstanding advantage that a memory bandwidth is widened by inhibiting units relevant to the processing of converting the SD signal, for example, in the aforesaid examples, the capture unit 13 and motion-picture processing unit 14 from acting.

In a signal processing system to which the present invention is applied, the host CPU 20 autonomously senses the connecting situations of cables, that is, whether a user has pulled out or inserted any of the cables. Therefore, an advantage that users need not manipulate a configuration menu or the like is provided.

A description has been made on the assumption that the output signal to be sent via the output terminal is a video signal. The video signal is presented as a mere example. Any other signal such as an audio signal may be adopted as the output signal.

The present invention is not limited to the BD reproducing system or BD recording system but may be applied to all signal processing systems including systems that employ an optical disk, a magneto-optical disk, a tape medium, or a flash memory medium.

In the present embodiment, for example, terminal connection information is adopted as state information on the connecting destination of a terminal. However, as mentioned above, the connecting-destination state information may be information with which the host CPU 20 can recognize the state of the connecting destination of the terminal 19 (including an unconnected state), but is not especially limited to any specific form. The connecting-destination state information may take on any form.

For example, the host CPU may communicate with a connecting destination and the contents of the communication may be adopted as the connecting-destination state information. More particularly, for example, when the connecting destination authenticates a signal processing system, to which the present invention is applied, through communication, information signifying that the authentication has succeeded may be adopted as the connecting-destination state information. In this case, before the information signifying that the authentication has succeeded is transmitted, the signal processing system to which the present invention is applied recognizes as the state of the connecting destination a state in which the connecting destination can treat an output signal sent via the terminal thereof. Meanwhile, units that belong solely to a data path leading to the terminal that serves as an output terminal are inhibited from acting. Thereafter, in a stage in which the information signifying that the authentication has succeeded is transmitted, the signal processing system to which the present invention is applied recognizes the transition of the state of the connecting destination into a state in which the connecting destination can treat the output signal sent via the terminal thereof. In this stage, the transition of the state of the units belonging solely to the data path leading to the terminal serving as an output terminal is made from the inhibited state to a permitted state. Thus, the units are not permitted to act until the authentication succeeds. The action-suspended time of the units gets longer than the time during which the units are permitted to act in a stage in which the cable is coupled to the terminal. This contributes to power saving of the entire signal processing system.

In the aforesaid examples, control for validating or invalidating a data path leading to a terminal serving as an output terminal according to the state of the connecting destination of the terminal, control for permitting units (circuits), which belong to the data path, to act or inhibiting the units from acting is implemented. However, the control technique is not limited to that employed in the aforesaid examples. Alternatively, the data path leading to the terminal serving as an output terminal may be variably controlled, or a signal processing technique to be applied to a signal transmitted over the data path may be variably controlled. Namely, the control for validating or invalidating the data path is a mere example of variable control of the data path leading to the terminal serving as an output terminal. The control for permitting the units (circuits), which belong to the data path, to act or inhibiting the units from acting is a mere example of variable control of the signal processing technique to be applied to the signal transmitted over the data path.

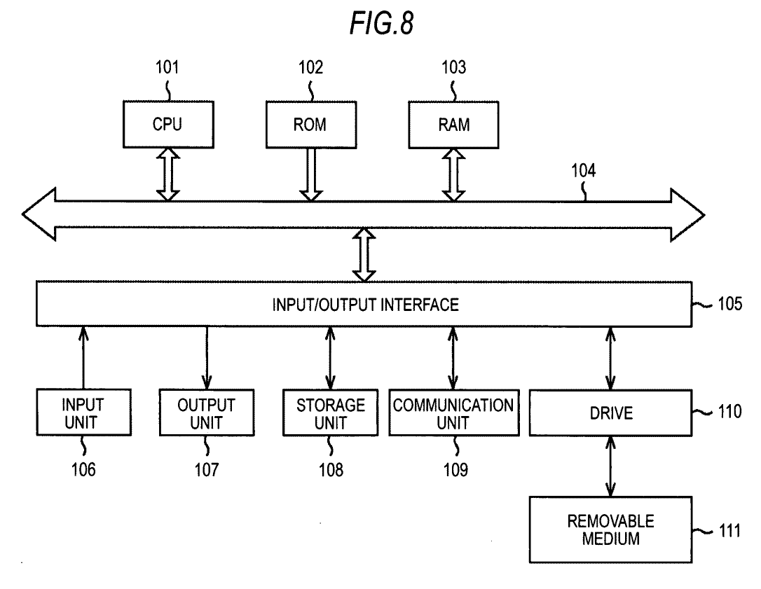

When the aforesaid series of pieces of processing is executed by software, a signal processing system to which the present invention is applied may be configured to include a computer shown in FIG. 8. Otherwise, driving the signal processing system to which the present invention is applied may be controlled by the computer shown in FIG. 8.

In FIG. 8, a CPU 101 executes various kinds of pieces of processing according to programs recorded in a read-only memory (ROM) 102 or programs loaded from a storage unit 108 to a random access memory (RAM) 103. In the RAM 103, data items which the CPU 101 uses to execute the various kinds of pieces of processing are stored appropriately.

The CPU 101, ROM 102, and RAM 103 are interconnected over a bus 104. An input/output interface 105 is connected onto the bus 104.

An input unit 106 formed with a keyboard and a mouse, an output unit 107 formed with a display, a storage unit 108 formed with a hard disk or the like, and a communication unit 109 formed with a modem and a terminal adaptor are connected to the input/output interface 105. The communication unit 109 controls communication to be performed with any other system (not shown) over a network such as the Internet.

A drive 110 is, if necessary, connected to the input/output interface 105. A removable medium 111 realized with a magnetic disk, an optical disk, a magneto-optical disk, or a semiconductor memory is appropriately mounted in the drive 110. A computer program read from the removable medium is, if necessary, installed in the storage unit 108.

When a series of pieces of processing is executed by software, a program in which the software is implemented is installed in a computer incorporated in dedicated hardware, or in, for example, a general-purpose personal computer, which can execute various functions when having various kinds of programs installed therein, over a network or from a recording medium.

The recording medium containing the program is, as shown in FIG. 8, the removable medium (package medium) 111 that is distributed independently of a main body of the system to viewers in order to provide the program, and that is realized with a magnetic disk (including a floppy disk), an optical disk (including a compact disk-read-only memory (CD-ROM) and a digital versatile disk (DVD)), a magneto-optical disk (including a mini-disk (MD)), or a semiconductor memory. Otherwise, the recording medium may be the ROM 102 in which the program is recorded and which is provided for viewers while being incorporated in advance in the main body of the system, or a hard disk included in the storage unit 108.

In this specification, the steps according to which the program recorded in a recording medium is described include not only pieces of processing to be time-sequentially performed in order but also pieces of processing that are not always time-sequentially performed but are executed in parallel with one another or independently of one another.

In this specification, what is referred to as a system is an entire system composed of multiple devices and processing units.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing system comprising:
one or more terminals via which a signal is outputted; and
signal control means for sensing whether the connecting destination of each of the one or more terminals is in a state in which the connecting destination can treat an output signal sent via the terminal, and implementing at least one of variable control of a signal transmission path, which leads to the terminal serving as an output terminal, and variable control of a signal processing technique, which is applied to the signal transmission path, on the basis of the result of the sensing.

2. The signal processing system according to claim 1, wherein:
one or more circuit blocks belong to the signal transmission path; and
the signal control means controls, as the variable control of the signal processing technique, permission of the one or more circuit blocks, which belong to the signal transmission path, to act and inhibition thereof from acting.

3. The signal processing system according to claim 2, wherein:
a memory also belongs to the signal transmission path; and
the signal control means controls permission of circuit blocks, which are connected to the memory, to act and inhibition thereof from acting.

4. The signal processing system according to claim 1, wherein the signal control means senses a physical state of connection of the terminal as the state of the connecting destination of the terminal.

5. The signal processing system according to claim 1, wherein the signal control means communicates with the connecting destination of the terminal, and senses the state of the connecting destination of the terminal on the basis of the contents of the communication.

6. A signal processing method comprising the steps of:
causing a signal processing system, which includes one or more terminals via which a signal is outputted, to sense whether the connecting destination of each of the one or more terminals is in a state in which the connecting destination can treat an output signal sent via the terminal; and
causing the signal processing system to implement at least one of variable control of a signal transmission path, which leads to the terminal serving as an output terminal, and variable control of a signal processing technique, which is applied to the signal transmission path, on the basis of the result of the sensing.

7. A program causing a computer, which controls an output device having one or more terminals via which a signal is outputted, to:
sense whether the connecting destination of each of the one or more terminals is in a state in which the connecting destination can treat an output signal sent via the terminal; and
implement at least one of variable control of a signal transmission path, which leads to the terminal serving as an output terminal, and variable control of a signal processing technique, which is applied to the signal transmission path, on the basis of the result of the sensing.

8. A signal processing system comprising:
one or more terminals via which a signal is outputted; and
a signal control unit configured to sense whether the connecting destination of each of the one or more terminals is in a state in which the connecting destination can treat an output signal sent via the terminal, and implement at least one of variable control of a signal transmission path, which leads to the terminal serving as an output terminal, and variable control of a signal processing technique, which is applied to the signal transmission path, on the basis of the result of the sensing.
